(19) United States
(12) Patent Application Publication
(10) Pub. No.: US 2026/0037987 A1
(43) Pub. Date: Feb. 5, 2026

(54) SYSTEMS AND METHODS FOR TRACKING PURCHASED ELECTRICITY EMISSIONS

(71) Applicant: Hygge Energy Inc., Toronto (CA)

(72) Inventors: Rajagopalan Krishnamurthy, Cupertino, CA (US); Sanjeev Sinha, Kolkata (IN); Pankaj Tambe, Bangalore (IN)

(21) Appl. No.: 18/790,067

(22) Filed: Jul. 31, 2024

(51) Int. Cl. G06Q 30/018; G06Q 50/06

(52) U.S. Cl. CPC G06Q 30/018; G06Q 50/06

(57) ABSTRACT

Described are various embodiments of system and method for tracking purchased electricity emissions. In one embodiment, a method for determining a carbon footprint of at least one energy consuming process comprises the steps of: surveilling, by a processor, for a designated time interval, an amount of electricity produced by the one or more sources of generation. For each source of generation in said designated time interval, a carbon-footprint of the generated electricity is determined. Electricity consumed by the energy consuming process during said designated time interval can be monitored, in some cases, via one or more local monitoring devices. For each source of generation, a corresponding proportion of the electricity consumed to the energy produced is assigned for the designated time interval. A carbon footprint of the energy consumed for the designated time interval is calculated using the proportion and said carbon footprint of the generated electricity.

### FIELD OF THE DISCLOSURE

The present disclosure relates energy monitoring, and, in particular, to systems and methods for tracking purchased electricity emissions.

### BACKGROUND

Due to the increasing importance of climate change, reducing carbon footprint of their products and operations is fast becoming an important objective for corporates all across the globe. Governments all over the world are putting regulations in place that would mandate industries to monitor, report and reduce their carbon footprint. For example, India will shortly be announcing the emission caps for hard-to-abate industries like Iron and Steel, Cement, Petro chemicals and Paper/Pulp in the initial phase of implementation, which will be extended to other industries in the next phases. If the emission caps are not met, it will mean additional costs for companies in terms of the carbon offsets which they will have to purchase from the market. The EU is also mandating importers to report the carbon footprint of the products entering the EU. In case the emissions are above the norms, such products will attract additional tariffs and adjustment mechanisms. In cases where emissions exceed allowable thresholds, additional taxes or costs will be applied to the batches. Importers failing to comply with reporting mandates will also face non-compliance fines.

“Scope 2” emissions (as defined in the Greenhouse Gas Protocol) are the emissions related to purchased or acquired electricity, steam, heating, and cooling, for example in the manufacturing processes of industries. They are emissions that a company causes indirectly and come from where the energy it purchases and uses is produced. One of the parameters in the mix is grid intensity, also known as grid mix. This typically refers to the carbon intensity and the mix of the various sources of electricity such as solar, wind, coal, hydrocarbon, hydroelectric, geothermal, etc. The expression “carbon intensity” as used herein should be understood to include any measure of how “clean” or “green” an amount of electricity is. For example, it may include a weight (in grams, etc.) of carbon dioxide (CO2) released to produce an amount of electricity (for example in kilowatt-hour—kWh). Electricity generated using fossil fuels is more carbon intensive as it generates more CO2 emissions. In contrast, renewable energy sources, such as wind, hydro or solar power, produce next to no CO2 emissions, and their carbon intensity value is much lower, and often zero. Using electricity with a lower carbon intensity value allows to reduce overall emissions, especially if consumption of that electricity is done at times when renewable sources are most productive.

The mix of the energy actually delivered by the grid is an important variable that determines the true carbon footprint. This mix fluctuates over time, and as the share of the renewable energy continues to grow, grid intensity will increasingly vary based on the time of day. In contrast, most calculations of carbon footprint use a long-term average number (such as the annual solar production) to represent the contributions of clean energy and those from non-renewable sources in the grid mix, and this leads to highly inaccurate estimates. Since electrification is one of the key measures used by industries to reduce their overall emissions (Scope 1 and Scope 2), the impact of Scope 2 emissions forms a major part of the overall emissions reduction approach of the hard-to-abate industries specified above. In some cases, grid mix represents the only source of carbon footprint, for example in data centers, as well as many industries like hotel industry, telecommunications, hospitals etc., where the manufacturing process doesn't produce any additional emissions. Thus, accurately assessing the grid mix can hugely impact the apparent carbon footprint of any industry.

Electrification is one of the most preferred tools in reducing emissions and carbon footprint. Electrification by itself does not ensure carbon footprint reduction unless it is sourced from clean sources and accounted properly. Companies make big investments in purchasing renewable energy to support electrification, either on site or under open access or in a mix of both. In addition, regulators are seeking a more accurate assessment of carbon footprint, that is not based on averages but on real time/near-real time basis. International bodies, governments, and regulatory institutions are increasingly demanding a granular reconciliation (such as minute by minute) accounting of the Scope 2 emissions and its impact on decarbonizing Scope 1 electrification efforts. To respond to this need, utilities need solutions that can provide granular record of the grid mix of the energy being distributed by them.

This background information is provided to reveal information believed by the applicant to be of possible relevance. No admission is necessarily intended, nor should be construed, that any of the preceding information constitutes prior art or forms part of the general common knowledge in the relevant art.

### SUMMARY

The following presents a simplified summary of the general inventive concepts described herein to provide a basic understanding of some aspects of the disclosure. This summary is not an extensive overview of the disclosure. It is not intended to restrict key or critical elements of embodiments of the disclosure or to delineate their scope beyond that which is explicitly or implicitly described by the following description and claims.

A need exists for systems and methods for tracking purchased electricity emissions that advantageously allows to measure the power produced and consumed on a real time/near real-time basis, while tracking the green energy mix, and accurately attributing it to specific applications and their impacts on decarbonization. They accurately provide a measure of the scope 2 emissions from a commercial and/or industrial consumer.

In accordance with a first aspect, there is provided a computer-implemented method for determining a carbon footprint of at least one energy consuming process, the energy consuming process receiving energy from one or more sources of generation, comprising the steps of: surveilling, by a processor, for a designated time interval, an amount of electricity produced by each of the one or more sources of generation; determining, by the processor, for each source of generation in said designated time interval, a carbon-footprint of the generated electricity; monitoring, by the processor, electricity consumed by the energy consuming process during said designated time interval; assigning, by the processor, for the designated time interval, for each source of generation, a corresponding proportion of the electricity consumed to the energy produced; calculating, by the processor, using said proportion and said carbon footprint of the generated electricity, a carbon footprint of the energy consumed for the designated time interval.

In some embodiments, the monitoring is done, at least in part, via one or more local monitoring devices, the local monitoring device coupled electrically or communicatively to the at least one energy consuming process and configured to monitor electricity consumed by the energy consuming process.

In some embodiments, the energy consuming process is a manufacturing process producing one or more articles, further comprising the steps of: acquiring, by the processor, a number of articles produced in said designated time interval by the manufacturing process; and computing, by the processor, a per-article carbon footprint using both a number of articles produced and the carbon footprint of the energy consumed in the designated interval period.

In some embodiments, at least one of said one or more sources of generation comprises a grid electricity producer, and wherein said surveilling is done, at least in part, by fetching, by the processor over a network, energy-production related data made available by a load dispatch center of the grid electricity producer.

In some embodiments, the carbon footprint of the generated electricity is determined, at least in part, by identifying from an energy-production related data a type of generator used to produce the generated electricity by the grid electricity producer.

In some embodiments, the one or more sources of generation comprise at least one local source of generation, and wherein said surveilling is done, at least in part, by measuring a local amount of electricity produced by the local source of generation via a smart energy meter, the smart energy meter communicatively coupled to the processor via one or more networks.

In some embodiments, the local source of generation comprises at least one of: a dispatchable source of generation or a renewable source of generation.

In some embodiments, the local source of generation comprises a battery storage device, and further comprising the steps of: determining, by the processor, from said amount of electricity produced, an amount of electricity being stored in the battery storage device in said designated time interval; assigning, by the processor, for each source of generation, a corresponding proportion of the electricity stored to the energy produced; measuring, by the processor, from the electricity stored, an amount of electricity released from the battery storage device and consumed by the energy consuming process; wherein said calculating is done by further including said proportion of electricity stored and released.

In some embodiments, the computer-implemented method further comprises the step of: producing one or more certificates to be stored on a blockchain comprising at least one of: said amount of electricity produced, said carbon footprint of the generated electricity, said electricity consumed and said carbon footprint of the energy consumed.

In some embodiments, each certificate further comprises: a certificate ID, the designated time interval, and one or more identifiers associated with each source of generation.

In accordance with another aspect, there is provided a system for determining a carbon footprint of at least one energy consuming process, comprising: at least one server, the server comprising at least one processor coupled to a non-transitory computer-readable memory and network adapter; the memory comprising instructions that, when executed by the processor, cause the processor to: surveil for a designated time interval an amount of electricity produced by the one or more sources of generation; determine, for each source of generation in said designated time interval, a carbon-footprint of the generated electricity; monitor via one or more local monitoring devices, electricity consumed by the energy consuming process during said designated time interval; assign for the designated time interval, for each source of generation, a corresponding proportion of the electricity consumed to the energy produced; and calculate, using said proportion and said carbon footprint of the generated electricity, a carbon footprint of the energy consumed for the designated time interval.

In some embodiments, the system further comprises at least one local monitoring device in communication with the at least one server via at least one network, the local monitoring device coupled electrically or communicatively to the at least one energy consuming process and configured to monitor electricity consumed by the energy consuming process.

In some embodiments, the energy consuming process is a manufacturing process producing one or more articles, and wherein the instructions further cause the processor to: acquire a number of articles produced in said designated time interval by the manufacturing process; and compute a per-article carbon footprint using both a number of articles produced and the carbon footprint of the energy consumed in the designated time interval.

In some embodiments, at least one of said one or more sources of generation comprises a grid electricity producer, and wherein said surveilling is done, at least in part, by fetching, by the server over via the at least one network, energy-production related data made available by a load dispatch center of the grid electricity producer.

In some embodiments, the carbon footprint of the generated electricity is determined, at least in part, by identifying from an energy-production related data a type of generator used to produce the generated electricity by the grid electricity producer.

In some embodiments, the one or more sources of generation comprise at least one local source of generation, and wherein the system further comprises, for each local source of generation, a smart energy meter electrically or communicatively coupled to the source of generation and in communication with the server, and wherein said surveilling is done, at least in part, by measuring, by the smart energy meter, a local amount of electricity produced by the local source of generation by the smart energy meter.

In some embodiments, the local source of generation comprises a battery storage device, and wherein the at least one monitoring device is configured to determine, from said amount of electricity produced, an amount of electricity being stored in the battery storage device in said designated time interval and from the electricity stored, an amount of electricity released from the battery storage device and consumed by the energy consuming process; and wherein the instructions further cause the processor to: assigning, for each source of generation, a corresponding proportion of the electricity stored to the energy produced; and wherein said calculating is done by further including said proportion of electricity stored and released.

In some embodiments, the instructions further cause the processor to: produce one or more certificates to be stored on a blockchain comprising at least one of: said amount of electricity produced, said carbon footprint of the generated electricity, said electricity consumed and said carbon footprint of the energy consumed.

In some embodiments, each certificate further comprises: a certificate ID, the designated time interval, and one or more identifiers associated with each source of generation.

Other aspects, features and/or advantages will become more apparent upon reading of the following non-restrictive description of specific embodiments thereof, given by way of example only with reference to the accompanying drawings.

### BRIEF DESCRIPTION OF THE DRAWINGS

Several embodiments of the present disclosure will be provided, by way of examples only, with reference to the appended drawings, wherein:

FIG. 1 is a schematic diagram illustrating a scope 2 emission monitoring system, in accordance with one embodiment; and

FIG. 2 is a schematic diagram of a local monitoring device, in accordance with one embodiment.

FIG. 3 is a flow diagram illustrating a method for processing energy-related data via blockchain, in accordance with one embodiment; and

FIG. 4 is a schematic diagram illustrating the chain of trust established by the method of FIG. 3, in accordance with one embodiment.

Elements in the several drawings are illustrated for simplicity and clarity and have not necessarily been drawn to scale. For example, the dimensions of some of the elements in the figures may be emphasized relative to other elements for facilitating understanding of the various presently disclosed embodiments. Also, common, but well-understood elements that are useful or necessary in commercially feasible embodiments are often not depicted in order to facilitate a less obstructed view of these various embodiments of the present disclosure.

### DETAILED DESCRIPTION

Various implementations and aspects of the specification will be described with reference to details discussed below. The following description and drawings are illustrative of the specification and are not to be construed as limiting the specification. Numerous specific details are described to provide a thorough understanding of various implementations of the present specification. However, in certain instances, well-known or conventional details are not described in order to provide a concise discussion of implementations of the present specification.

Furthermore, numerous specific details are set forth in order to provide a thorough understanding of the implementations described herein. However, it will be understood by those skilled in the relevant arts that the implementations described herein may be practiced without these specific details. In other instances, well-known methods, procedures and components have not been described in detail so as not to obscure the implementations described herein.

In this specification, elements may be described as “configured to” perform one or more functions or “configured for” such functions. In general, an element that is configured to perform or configured for performing a function is enabled to perform the function, or is suitable for performing the function, or is adapted to perform the function, or is operable to perform the function, or is otherwise capable of performing the function.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

The systems and methods of the present disclosure allows to monitor various sources of energy generation on a real time or near real time basis and then match the energy production with the energy consumed in, for example, one or more manufacturing processes. This enables utilities to track carbon emission intensity from the generator to the end customer at any given point in time. The monitoring system and method leads to accurate estimation of the grid intensity of the generation sources, which are then mapped to specific electricity consuming entities.

In some cases, this includes using utility time-stamped smart meter data to track the purchased amounts of electricity from various generators, including but not limited to coal-fired, natural gas, solar, wind sources, or others. The data from these smart meters is typically recorded at a designated time interval (e.g., 15-minute intervals). This means that for each interval, the type and quantum of electricity purchased by the distribution utility and distributed to its industrial customers are known. In cases where such time-stamped data is not already instrumented, one or more monitoring devices may be used to create such records while maintaining the chain of trust, for example by using blockchain technology. Once the green attributes are accurately matched in real time or near real-time between the different sources of generation at one end, and the actual consumption at the other, one can very accurately determine the carbon foot-print of the energy consumed. Since this matching or tallying of energy is time stamped, one can accurately determine, batch-wise, the scope 2 emissions of any energy consuming process. In some embodiments, when the energy consuming process is a manufacturing process where the manufacturing process output is also time-stamped (i.e., each finished goods are time stamped from start to finish), the system and method can further accurately determine the scope 2 emissions of individual products and therefore total carbon foot-print of the goods produced. The measurements are provided on-line, in addition to being measurable, auditable and tamper-proof.

The present systems and methods may be used with the systems and methods disclosed in U.S. Pat. Nos. 11,742,688; 11,921,480; U.S. patent application Ser. No. 18/146,017; and/or CA U.S. Pat. No. 3,171,151, which are all commonly assigned, and the contents of which are incorporated by reference herein in their entirety.

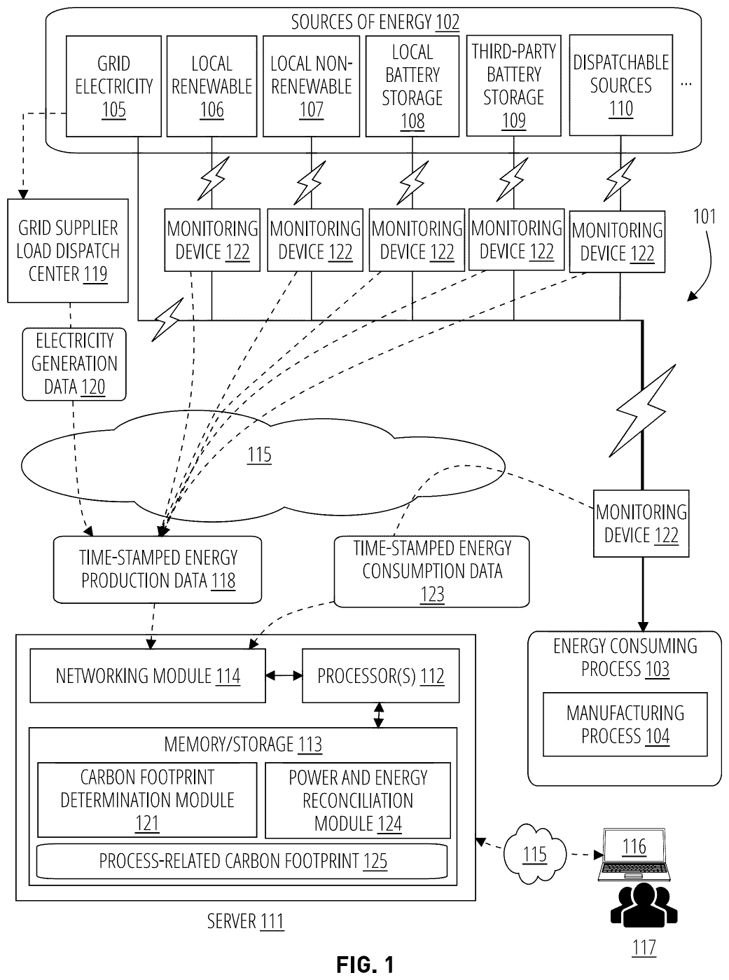

FIG. 1 is a schematic representation of a purchased electricity emission tracking system 101, in accordance with one embodiment. The system 101 is used to track or monitor scope 2 emissions from purchased or acquired energy, like electricity, that is generated off-site by one or more sources of energy 102 and consumed by the reporting company, for example in one or more energy consuming processes 103, such as manufacturing processes 104. It will be appreciated that the system 101 described herein may be configured to work any source of energy used/purchased to operate one or more energy consuming processes. These may include, for example and without limitation:
a. grid electricity 105, including private procurement through power purchase agreements;
b. local renewable energy power generating stations 106 (i.e., biomass, biogas, geothermal, hydro, solar, wind, etc.);
c. local non-renewable energy power generating stations 107;
d. local battery storage 108 (including, for example, smaller batteries or mobile batteries, such as vehicular batteries, etc.);
e. battery storage provided by a utility or third-party 109 (including, for example, larger non-mobile batteries, including for example batteries dedicated to servicing a community, multiple buildings, etc.); and/or
f. dispatchable sources 110 (including, for example, fuel cells-hydrogen, hydrocarbon, etc., small natural gas plants, and/or diesel generating sets).

The energy consuming process 103 may include any process(es), device(s), machinery, system(s) or the like configured to use the purchased or acquired energy provided by the one or more sources of energy 102 to perform some type of work. In some embodiments, this may include one or more manufacturing processes 104 that manufacture one or more articles or goods. It can also include using the energy to heat or cool building, or more generally to operate different kinds of devices and/or systems. In the depicted embodiment, the system 101 is a cloud-based system and comprises at least one server 111 having one or more processors 112 coupled to a memory/storage 113 and networking module 114 in communication with one or more networks (for example the Internet 115). While only one server 111 is illustrated in FIG. 1 for clarity only, it will be appreciated that a plurality of servers communicatively coupled to one another may be used as well. Different modules and/or functions described in the context of server 111 below may be distributed on two or more servers, as will be appreciated by the skilled person in the art. The server is configured to generate a time stamped summation of the carbon intensity or footprint from all the sources of energy 102 to obtain the total carbon footprint of the energy acquired for the manufacturing process 104 (for example). The carbon intensity or footprint may be measured or calculated using different metrics/units, but may be expressed for example as an amount or weight of CO2 (e.g., in kg, etc.) per unit of energy produced/consumed (e.g., in kWh or other). Similarly, the time-stamped consumption of energy at the manufacturing process 104 is also monitored. Therefore, a time-stamped, real time/near-real time accurate estimation of a scope 2 related carbon footprint of the manufacturing process 104 may be determined, which itself may be used to estimate a carbon footprint for each batch/product made by the manufacturing process 104. This information and more may be accessed remotely by a user device 116 (e.g., laptop, desktop computer, phone, tablet, etc.) of one or more users 117.

The server 111 is configured to acquire or receive time-stamped energy production data 118 from the one or more sources of energy 102. In some cases, the server 111 may be configured to interface with one or more dispatch centers, and/or in other cases it may interface with local monitoring devices. It is also configured to assign a carbon footprint amount to the energy based on the source.

For example, in the case of grid electricity 105, in some embodiments, the server 111 is configured to communicate with at least one grid supplier load dispatch center 119 (or online database and/or server operated by one or more grid electricity producer) to receive therefrom time-stamped grid electricity generation data 120. Utilities in some countries are required to adopt a system that reports the energy supplied to the grid at a higher frequency, for example in 15-minute intervals. In such cases, the grid supplier load dispatch center 119 can provide time-stamped electricity generation data 120 on which generators supplied how much of the energy in each the designated 15-minute intervals. Communications between the server 111 and the dispatch center 119 may be done in different ways, but typically includes exchanging information or data via an API. The server 111 is configured to store a copy of all records received. The electricity generation data 120 also comprises a carbon intensity of the electricity generated. This may include a power mix of the grid on a real-time or semi real-time basis (e.g., 24×7 basis). The server 111 may, via a carbon footprint determination module 121, split or categorize the recorded electricity generation data 120 by each different type of generator and/or energy mix by time block. The power or energy mix may include energy data from generators who have been dispatched through the spot markets via the power exchanges. It may also include the ability to provide generator specific power dispatch data in real-time or near real-time, in case of Open Access and/or Power Purchase Agreements (PPA) related energy purchases.

The server 111 may further be configured to receive time-stamped energy production data 118 from one or more local energy monitoring devices 122 (also referenced to interchangeably herein using the expression “smart meters”) adapted to measure the energy produced locally by the one or more local sources of energy. Similarly, one or more additional local monitoring devices 122 may also be used to monitor or measure electricity consumed for the energy consuming process 103. Typically, each energy monitoring device or box is configured to measure/monitor energy generated/consumed in real-time or near real-time with time stamps. Therefore, a monitoring device 122 may be coupled directly or indirectly, electrically and/or communicatively, with an energy source to monitor energy production at one end, and another such device may be coupled to an energy consuming device or system to monitor energy consumption at the other end.

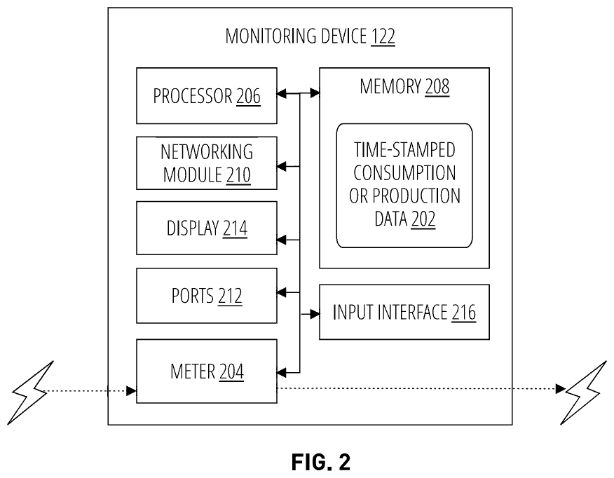

With additional reference to FIG. 2, the local monitoring device will now be discussed. FIG. 2 shows a schematic diagram of an exemplary local monitoring device 122, which is used to, in some embodiments, acquire time-stamped consumption or production data 202 to be relayed to the server 111.

Non-limiting examples of such monitoring devices may comprise some or all the functionalities of the monitoring devices or boxes described in CA Patent No. 3,171,151. These may be used to obtain information from each site load relating to what application the electrical energy is used for. The application information may be obtained for example from building management systems, for instance when an air conditioner and/or heater turns on, and/or to obtain application information from electrical vehicle chargers when an electrical vehicle is plugged in and charging. In addition, an approach known as power disaggregation may be applied by the monitoring devices which identifies various loads by their power signature. In some embodiments, the monitoring devices or boxes may be configured to host an embedded node containing a record of the blockchain.

In some embodiments, the data may be acquired by the device 122 by measuring an electrical voltage, current and/or power of an electrical system or device using for example an integrated meter or measuring device 204. In some embodiments, the monitoring device 122 may instead, or addition to, be communicatively coupled to the electrical system or a controller thereof and receive the production/consumption data via a network. Typically, the local monitoring device 122 comprises one or more processors 206 coupled to a non-transitory computer-readable memory 208, and a networking module 210 operable to communicate wirelessly to a network. Each monitoring device 122 may have enough memory 208 to store data thereon at the site for a limited amount of time, for example for a day.

The local monitoring devices 122 are configured to record and transmit time-stamped energy production 118 and energy consumption data 123. The production/consumption data is communicated to the cloud server 111 using one or more networks, like the Internet 115, which has to be made available at the site. This may include support for Wi-Fi (for example 802.11n or better) as well as mobile Internet. In some embodiments, local monitoring device 122 may be configured to support at-least one 4G nano-SIM card. In case the monitoring device 122 does not have these integrated communication capabilities, in some embodiments an external communication device or adapter coupled to the local monitoring device via one or more ports 212 may be provided to support the same features. In some embodiment, each local monitoring device 122 may have an internal power source (e.g., battery or the like—not shown), and/or may be able to receive power from one or more electrical outlet. In some embodiments, the local monitoring device 122 may comprise enough memory or storage to store data on the device for up to one year (i.e., 365 days data to be stored) so as to enable comparison and reporting.

In some embodiments, time-stamped energy production data 118 may be provided, at least in part, to the server 111 by being communicated by one or more users (if automated methods are not available), for example the one or more user devices 116.

On the production side, the server 111 may use the carbon footprint determination module 121 to associate a carbon intensity or footprint to the time-stamped energy production data 118. For example:
Local renewables 106: In some embodiments, energy produced by local renewable energy sources may have a carbon intensity of zero or NULL;
Local non-renewables 107: In some embodiments, the carbon intensity or footprint may be calculated or determined from a manufacturer rating entered by a user directly or via the monitoring device and stored on the server 111;
Local battery storage 108: In some embodiments, the local monitoring device 122 is used to monitor the energy flowing into a local battery storage device (for example from grid electricity) and a record of the carbon footprint of that energy is time tracked as discussed above. Thus, the carbon intensity or footprint of the energy used to charge the battery can be determined. When the energy is used, for example by the manufacturing process 104, the local monitoring device 122 tracks the energy released, and the carbon footprint of the energy consumed from the battery can be accurately estimated by the server 111 (non-limiting examples systems and methods to do so include those described in U.S. Pat. No. 11,742,688);
battery storage provided by a utility or third-party 109: In some embodiments, these larger battery storage devices may also be monitored similarly as described above for the smaller local batteries using one or more local monitoring devices 122;
Local dispatchable sources 110: In some embodiments, the carbon intensity or footprint of the energy generated by a diesel generating set can be estimated using the manufacturer's specifications. This information is provided to the carbon footprint determination module 121 which uses it to track carbon intensity of the energy released and monitored by the local monitoring device.

On the consumption side (i.e., energy consuming process 103), the local monitoring device 122 allows instantaneous monitoring of, for example, the AC power consumption, 24/7, at the consumer end at one or at multiple consumption points. Under normal circumstances, the local monitoring devices may transfer the data to the server 111 over one or more networks such as the Internet in designated time intervals or blocks (i.e., 15 mins). In some embodiments, the monitoring device 122 may be configured to monitor multiple parameters simultaneously, for instance AC voltage but also AC current, and instant power. This may include collation of total power consumption, voltage and current at the site on instantaneous basis. However, each device may use any approach known in the art to gather information about specific consuming devices or systems, and about when and how much energy is being consumed, including direct measurement or indirect means such as communicating to a controller on the consuming device for example. In addition, it will be appreciated that while a single local monitoring device 122 is illustrated at the consumption side in FIG. 1, in some embodiments, the energy consuming process 103 may require two or more such devices to be installed, without limitation. Moreover, the energy consumption information for a specified time block may be for the entire site and/or each consumption point at the site. These devices may be installed either to measure energy produced from local production sources, batteries, etc., or to measure energy used in an energy consuming process (such as a manufacturing process 104).

In some embodiments, the local monitoring device 202 may be configured to communicate and exchange data via a network with an energy producing/consuming entity, machine, device or system it is monitoring. This may include receiving power production/consumption data directly from the device (for example instead of or in addition to being directly electrically coupled thereto and relying on the measuring meter 204 or similar). Other embodiments may have each monitoring device configured to be authenticated by the server (e.g., server 111 or other) before being able to transfer energy production and/or consumption data to ensure the information received is from a verified source.

In some embodiments, some monitoring devices may comprise a digital display 214 and input interface 216 to provide a dashboard allowing users to monitor individual power consumption or total power consumption locally at the site. The dashboard may provide historic views and comparison of data across days/weeks/months or other designated time intervals. In some embodiments, the monitoring device 122 may also have one or more ports 212 for connecting to an external input/output device for communication during configuration and maintenance works.

Importantly, the monitoring devices 122 used at the consumption end may be so configured such that any failure at their end should not impact the power/energy consumption of the energy consuming process. Thus, each device may be configured with adequate safety circuits/measures to ensure that any failure on the monitoring devices do not impact the consumer process/power/energy consumption in any manner. In such manner, the server 111 may be configured to calculate the carbon intensity using an alternate method for one or more monitoring devices, including, for example, by receiving the required data via a network directly from the energy consuming devices or systems, or a controller thereof, without the need to be directly electrically coupled to these devices or systems.

The power and energy reconciliation module 124 of server 111 comprises instructions that allow the system 101 to provide a real-time or near real-time (e.g., 24 h×7 days) reconciliation of the power mix received from the grid and/or locally produced power and consumption. It maps the overall energy mix for a given time block, onto the energy consumed, thereby generating a continuous data stream of the energy mix at the consumption end and/or generating the data stream as per time blocks. This is used as the basis to determine the energy mix at the consumption end, and is used to calculate the process-related carbon footprint 125 for the period in question (e.g., time block). This allows a user to receive a time-stamped measure of the carbon footprint of the energy used at the site/s, for any selected time interval or period. If in addition a number of items or articles produced by the manufacturing process 104 for the same time period is also known, then the power and energy reconciliation module 124 may further calculate a per-article carbon footprint.

In some embodiments, data may be stored on the local monitoring devices at the site. Data for up to one year may be stored on servers and data beyond the same may be stored on external drives/external storage devices. In some embodiments, the time-stamped production or consumption data may be recorded in a tamper-proof manner, for example using one or more blockchain-based methods to establish and preserve a chain of trust. For example, in some embodiments, using a designated time interval (e.g., 15-minute or other) provides granularity of data for Scope 2 emissions and allows automatic generation of time- and date-specific certificates. The server 111 may be configured to provide a meticulous and detailed record of the transfer between the utility and the entity, generating certificates that include, for example, the certificate ID, entity's name, the CO2 emissions amount over any specified interval, and any other relevant information. These certificates can be obtained from the server 111 for verification purposes by any stakeholder. Transparency and the verification process are powered by blockchain since each certificate generated gets published to the blockchain.

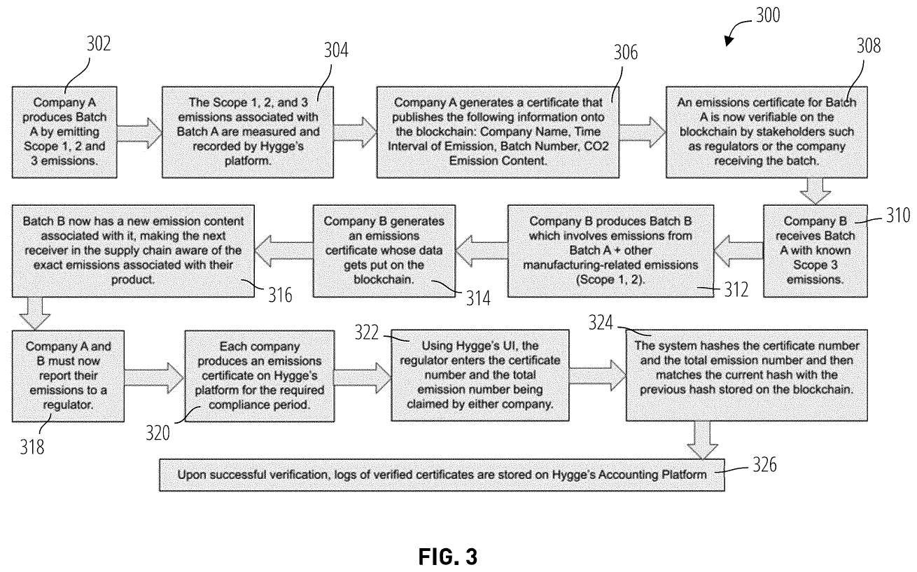

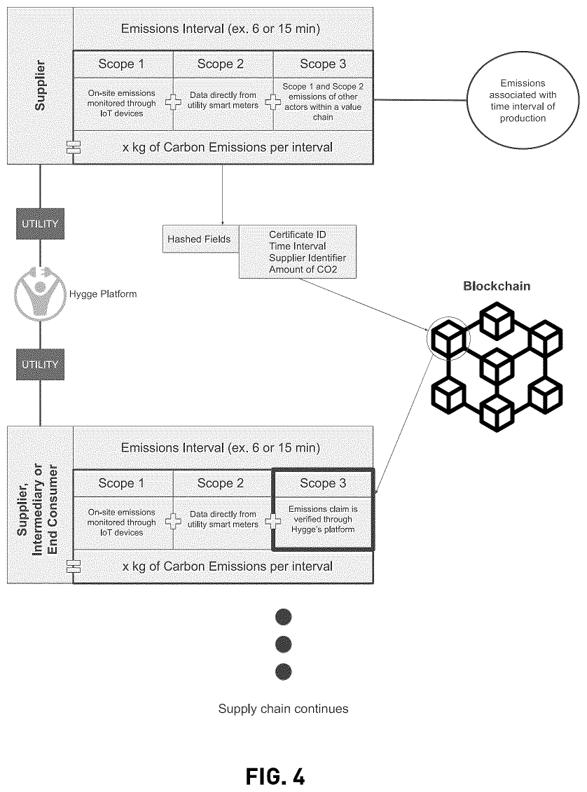

FIG. 3 illustrates an exemplary method 300 performed by the system 101 by which emissions are directly attributed to produced goods. By using utility and on-site smart meter data, emissions are calculated in real-time or near real-time and linked to each batch as it progresses through the supply chain. This allows entities and regulators to openly verify the emissions associated with each batch, establishing a transparent chain of emissions data for specific end-products. At step 302, a company (e.g., company A) produces a first batch (e.g., Batch A) by emitting scope 1, 2 and 3 emissions. At step 304, the system 101 measures and records Scope 1, 2 and 3 emissions associated with Batch A. At step 306, the company A generates a certificate that publishes, for example, the following information onto the blockchain: Company Name, Time Interval of Emission, Batch Number, CO2 Emission Content (as shown for example in FIG. 4). At step 308, an emission certificate for Batch A is now verifiable on the blockchain by stakeholders such as regulators or the company receiving the batch. At step 310, another company (e.g., Company B), receives Batch A with known Scope 3 emissions. At step 312, Company B produces another batch (e.g., Batch B) which involves emissions form Batch A+other manufacturing-related emissions (Scope 1 and 2). At step 314, the Company B generates an emissions certificate whose data gets put on the blockchain. At step 316, this allows to associate a new emission content to Batch B, allowing the next receiver in the supply chain to be aware of the exact emissions associated with their product. At step 318, the Company A and B report their emissions to a regulator. At step 320, each company produces an emissions certificate using the system 101 for the required compliance period. At step 322, using for example a user interface provided remotely by the server 111, the regulator may enter the certificate number and the total emission number being claimed by either company. At step 324, the system 101, for example on the server 111, hashes the certificate number and the total emission number and then matches the current hash with the previous hash stored on the blockchain. Finally, at step 326, upon successful verification, logs of verified certificates are stored on the server 111 and/or any other accounting platform.

Advantageously, the system 101 does not require additional data from the utilities or entities. The utilities have real-time data from load dispatch, and therefore, access to information like the name of the generator, type of the generator, amount of energy delivered, and time block for the delivery. Data from an entity's on-site generation, if applicable, will also be accounted for. System 101 provides the most accurate representation possible of the exact emissions associated with a shipment, ensuring transparency throughout the entire supply chain for every company worldwide by allowing entities to generate carbon emission certificates hashed onto the blockchain for verification.

In some embodiments, all the reporting tasks and analysis are performed on the server 111 via a Cloud-based infrastructure that comprises industry standard security measures to prevent malicious access. While FIG. 1 only shows one server 111, it will be appreciated if two or more servers may be used to provide adequate redundancies so that any hardware or software failure does not prevent the ability of the system to provide 24×7 re-conciliation. The server 111 may be configured to report non-availability of data for over an hour (i.e., no data refresh for one hour or more) from any of the local monitoring devices or from the API used to communicate with the grid supplier.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations, and data stores are somewhat arbitrary, and particular operations are illustrated in the context of specific illustrative configurations. Finally, structures and functionality presented as discrete components in the example configurations may be implemented as a combined structure or component. These and other variations, modifications, additions, and improvements may fall within the scope of embodiments as described.

Any of the methods, algorithms, implementations, or procedures described herein can include machine readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a hard drive, or other memory devices, but persons of ordinary skill in the art will readily appreciate that the entire algorithm and/or parts thereof could alternatively be executed by a device other than a controller and/or embodied in firmware or dedicated hardware in a well-known manner (e.g., it may be implemented by an application specific integrated circuit (ASIC), a programmable logic device (PLD), a field programmable logic device (FPLD), discrete logic, etc.). Also, some or all of the machine-readable instructions depicted herein can be implemented manually as opposed to automatically by a controller, processor, or similar computing device or machine.

While the present disclosure describes various embodiments for illustrative purposes, such description is not intended to be limited to such embodiments. On the contrary, the applicant's teachings described and illustrated herein encompass various alternatives, modifications, and equivalents, without departing from the embodiments, the general scope of which is defined in the appended claims. Information as herein shown and described in detail is fully capable of attaining the above-described object of the present disclosure, the presently preferred embodiment of the present disclosure, and is, thus, representative of the subject matter which is broadly contemplated by the present disclosure.

What is claimed is:

1. A computer-implemented method for determining a carbon footprint of at least one energy consuming process, the energy consuming process receiving energy from one or more sources of generation, comprising the steps of:
surveilling, by a processor, for a designated time interval, an amount of electricity produced by each of the one or more sources of generation;
determining, by the processor, for each source of generation in said designated time interval, a carbon-footprint of the generated electricity;
monitoring, by the processor, electricity consumed by the energy consuming process during said designated time interval;
assigning, by the processor, for the designated time interval, for each source of generation, a corresponding proportion of the electricity consumed to the energy produced;
calculating, by the processor, using said proportion and said carbon footprint of the generated electricity, a carbon footprint of the energy consumed for the designated time interval.

2. The computer-implemented method of claim 1, wherein said monitoring is done, at least in part, via one or more local monitoring devices, the local monitoring device coupled electrically or communicatively to the at least one energy consuming process and configured to monitor electricity consumed by the energy consuming process.

3. The computer-implemented method of claim 1, wherein said energy consuming process is a manufacturing process producing one or more articles, further comprising the steps of:
acquiring, by the processor, a number of articles produced in said designated time interval by the manufacturing process; and
computing, by the processor, a per-article carbon footprint using both a number of articles produced and the carbon footprint of the energy consumed in the designated interval period.

4. The computer-implemented method of claim 1, wherein at least one of said one or more sources of generation comprises a grid electricity producer, and wherein said surveilling is done, at least in part, by fetching, by the processor over a network, energy-production related data made available by a load dispatch center of the grid electricity producer.

5. The computer-implemented method of claim 4, wherein the carbon footprint of the generated electricity is determined, at least in part, by identifying from an energy-production related data a type of generator used to produce the generated electricity by the grid electricity producer.

6. The computer-implemented method of claim 5, wherein said one or more sources of generation comprise at least one local source of generation, and wherein said surveilling is done, at least in part, by measuring a local amount of electricity produced by the local source of generation via a smart energy meter, the smart energy meter communicatively coupled to the processor via one or more networks.

7. The computer-implemented method of claim 6, wherein the local source of generation comprises at least one of: a dispatchable source of generation or a renewable source of generation.

8. The computer-implemented method of claim 6, wherein the local source of generation comprises a battery storage device, and further comprising the steps of:
determining, by the processor, from said amount of electricity produced, an amount of electricity being stored in the battery storage device in said designated time interval;
assigning, by the processor, for each source of generation, a corresponding proportion of the electricity stored to the energy produced;
measuring, by the processor, from the electricity stored, an amount of electricity released from the battery storage device and consumed by the energy consuming process;
wherein said calculating is done by further including said proportion of electricity stored and released.

9. The computer-implemented method of claim 1, further comprising the step of:
producing one or more certificates to be stored on a blockchain comprising at least one of: said amount of electricity produced, said carbon footprint of the generated electricity, said electricity consumed and said carbon footprint of the energy consumed.

10. The computer-implemented method of claim 9, wherein each certificate further comprises:
a certificate ID, the designated time interval, and one or more identifiers associated with each source of generation.

11. A system for determining a carbon footprint of at least one energy consuming process, comprising:
at least one server, the server comprising at least one processor coupled to a non-transitory computer-readable memory and network adapter; the memory comprising instructions that, when executed by the processor, cause the processor to:
surveil for a designated time interval an amount of electricity produced by the one or more sources of generation;
determine, for each source of generation in said designated time interval, a carbon-footprint of the generated electricity;
monitor via one or more local monitoring devices, electricity consumed by the energy consuming process during said designated time interval;
assign for the designated time interval, for each source of generation, a corresponding proportion of the electricity consumed to the energy produced; and
calculate, using said proportion and said carbon footprint of the generated electricity, a carbon footprint of the energy consumed for the designated time interval.

12. The system of claim 11, further comprising at least one local monitoring device in communication with the at least one server via at least one network, the local monitoring device coupled electrically or communicatively to the at least one energy consuming process and configured to monitor electricity consumed by the energy consuming process.

13. The system of claim 11, wherein said energy consuming process is a manufacturing process producing one or more articles, and wherein the instructions further cause the processor to:
acquire a number of articles produced in said designated time interval by the manufacturing process; and
compute a per-article carbon footprint using both a number of articles produced and the carbon footprint of the energy consumed in the designated time interval.

14. The system of claim 11, wherein at least one of said one or more sources of generation comprises a grid electricity producer, and wherein said surveilling is done, at least in part, by fetching, by the server over via the at least one network, energy-production related data made available by a load dispatch center of the grid electricity producer.

15. The system of claim 14, wherein the carbon footprint of the generated electricity is determined, at least in part, by identifying from an energy-production related data a type of generator used to produce the generated electricity by the grid electricity producer.

16. The system of claim 15, wherein said one or more sources of generation comprise at least one local source of generation, and wherein the system further comprises, for each local source of generation, a smart energy meter electrically or communicatively coupled to the source of generation and in communication with the server, and wherein said surveilling is done, at least in part, by measuring, by the smart energy meter, a local amount of electricity produced by the local source of generation by the smart energy meter.

17. The system of claim 16, wherein the local source of generation comprises a battery storage device, and wherein the at least one monitoring device is configured to determine, from said amount of electricity produced, an amount of electricity being stored in the battery storage device in said designated time interval and from the electricity stored, an amount of electricity released from the battery storage device and consumed by the energy consuming process; and
wherein the instructions further cause the processor to:
assigning, for each source of generation, a corresponding proportion of the electricity stored to the energy produced; and
wherein said calculating is done by further including said proportion of electricity stored and released.

18. The system of claim 11, wherein the instructions further cause the processor to:
produce one or more certificates to be stored on a blockchain comprising at least one of: said amount of electricity produced, said carbon footprint of the generated electricity, said electricity consumed and said carbon footprint of the energy consumed.

19. The system of claim 18, wherein each certificate further comprises: a certificate ID, the designated time interval, and one or more identifiers associated with each source of generation.
